(19) United States
(12) Patent Application Publication
(10) Pub. No.: US 2016/0262306 A1
(43) Pub. Date: Sep. 15, 2016

(54) Protective Shield Apparatus

(71) Applicants: John Macedonio, East North Port, NY (US); Zongqin Dai, East North Port, NY (US)

(72) Inventors: John Macedonio, East North Port, NY (US); Zongqin Dai, East North Port, NY (US)

(21) Appl. No.: 15/067,556

(22) Filed: Mar. 11, 2016

Related U.S. Application Data
(60) Provisional application No. 62/131,341, filed on Mar. 11, 2015.

(51) Int. Cl. A01D 34/416

(52) U.S. Cl. CPC A01D 34/4167

(57) ABSTRACT

A protective shield apparatus for a power trimmer is provided. The power trimmer has a lower shaft with a trimmer head attached thereto with the trimmer head spinning a trimmer wire. The protective shield apparatus comprises a telescopic adjusting rod having a first end and a second end with the first end of the rod capable of being secured to the lower shaft of the power trimmer. A dome cover is secured to the second end of the telescopic adjusting rod by a gimbal bearing. The dome cover remains at a horizontal position, parallel with a ground surface and above the trimmer head, even when the trimmer head is being used at an angle with the dome cover reducing the power trimmer's hazardous tendency to “throw” debris out as it trims.

### CLAIM OF PRIORITY

This patent application claims priority under 35 U.S.C. 119 (e) (1) from U.S. Provisional Patent Application Ser. No. 62/131,341 filed Mar. 3, 2015, of common inventorship herewith entitled, “Protective Safety Shield for Rotary Power Trimmer and Associated Use Thereof,” which is incorporated herein by reference as though the same were set forth in its entirety.

### FIELD OF THE INVENTION

The present invention pertains to the field of power tool accessories and, more particularly, to a protective shield capable of being fastened over the cutting head of a trimmer, thereby providing a 360-degree protective housing and dramatically reducing or eliminating the trimmer's hazardous tendency to “throw” debris out as it trims.

### BACKGROUND OF THE INVENTION

Often, improvements arise from the inspiration of consumers who have discovered in their daily lives a defect or a hidden potential in some commonly used product or technology, and have figured out a better way. One such improvement, designed to make a popular lawn-maintenance tool far safer, is the subject of this report. The need for this invention arises from the tendency of string-cutting, gas- or electric-powered weed-whackers, weed-eaters or weed-trimmers to fling and throw debris, from sticks to pebbles to random trash, out around them as they trim. Such flying debris presents a serious hazard to the operator of the weed-trimmer, as well as to passers-by, and to objects and property ranging from cars to house windows.

Accordingly, a need remains for, a protective shield in order to overcome at least one prior art shortcoming. The exemplary embodiment(s) satisfy such a need by providing a protective shield capable of being fastened over the cutting head of a trimmer that is convenient and easy to use, lightweight yet durable in design, versatile in its applications, and designed for providing a 360-degree protective housing and dramatically reducing or eliminating the trimmer's hazardous tendency to “throw” debris out as it trims.

### SUMMARY OF THE INVENTION

The present invention is a protective shield apparatus for a power trimmer. The power trimmer has a lower shaft with a trimmer head attached thereto with the trimmer head spinning a trimmer wire. The protective shield apparatus comprises a telescopic adjusting rod having a first end and a second end with the first end of the rod capable of being secured to the lower shaft of the power trimmer. A dome cover is secured to the second end of the telescopic adjusting rod by a gimbal bearing. The dome cover remains at a horizontal position, parallel with a ground surface and above the trimmer head, even when the trimmer head is being used at an angle with the dome cover reducing the power trimmer's hazardous tendency to “throw” debris out as it trims.

In addition, the present invention includes a method for constructing a protective shield apparatus for a power trimmer. The power trimmer has a lower shaft with a trimmer head attached thereto with the trimmer head spinning a trimmer wire. The method comprises providing a telescopic adjusting rod having a first end and a second end, securing the first end of the rod to the lower shaft of the power trimmer, securing a dome cover to the second end of the telescopic adjusting rod by a gimbal bearing, maintaining the dome cover at a horizontal position, parallel with a ground surface and above the trimmer head, even when the trimmer head is being used at an angle, and reducing the power trimmer's hazardous tendency to “throw” debris out as it trims.

The present invention further includes a protective shield apparatus for a power trimmer. The power trimmer has a lower shaft with a trimmer head attached thereto with the trimmer head spinning a trimmer wire. The protective shield apparatus comprises a telescopic adjusting rod having a first end and a second end with the first end of the rod capable of being secured to the lower shaft of the power trimmer. A transparent dome cover is secured to the second end of the telescopic adjusting rod by a gimbal bearing. At least one cutting means is associated with the dome cover for trimming the cutting wire to a desired length. A pair of opposite flaps are formed in the dome cover. The dome cover remains at a horizontal position, parallel with a ground surface and above the trimmer head, even when the trimmer head is being used at an angle wherein the dome cover reduces the power trimmer's hazardous tendency to “throw” debris out as it trims.

### BRIEF DESCRIPTION OF THE DRAWINGS

The novel features believed to be characteristic of the exemplary embodiment(s) are set forth with particularity in the appended claims. The disclosure itself, however, both as to its organization and method of operation, together with further objects and advantages thereof, may best be understood by reference to the following description taken in connection with the accompanying drawings in which:

FIG. 1 is a perspective view illustrating a power trimmer having a lower shaft and a trimmer head rotatably attached to the lower shaft.

FIG. 2 is a perspective view illustrating the trimmer head of the power trimmer of FIG. 1.

FIG. 3 is a perspective view illustrating a protective shield apparatus constructed in accordance with the present invention.

FIG. 4 is another perspective view illustrating the protective shield apparatus of FIG. 3 constructed in accordance with the present invention.

FIG. 5 is still another perspective view illustrating the protective shield apparatus of FIG. 3 constructed in accordance with the present invention.

FIG. 6 is a perspective view illustrating another embodiment of the protective shield apparatus constructed in accordance with the present invention.

FIG. 7 is an elevational side view illustrating a stabilizing washer of the protective shield apparatus constructed in accordance with the present invention.

FIG. 8 is an elevational side view illustrating a metal band of the protective shield apparatus constructed in accordance with the present invention.

FIG. 9 is an elevational side view illustrating slidable flaps of the protective shield apparatus constructed in accordance with the present invention.

FIG. 10 is another elevational side view illustrating the slidable flaps of the protective shield apparatus constructed in accordance with the present invention.

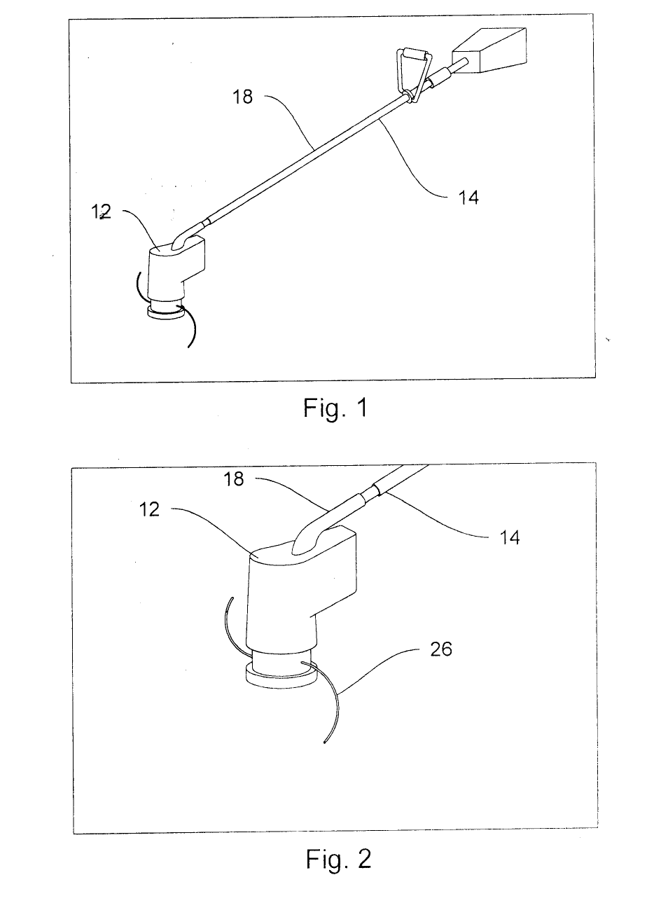

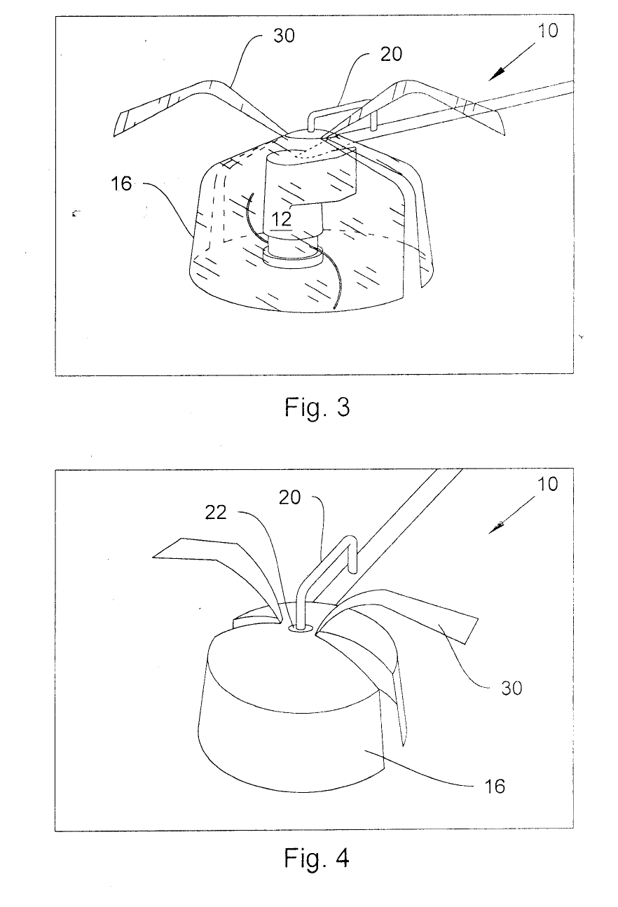

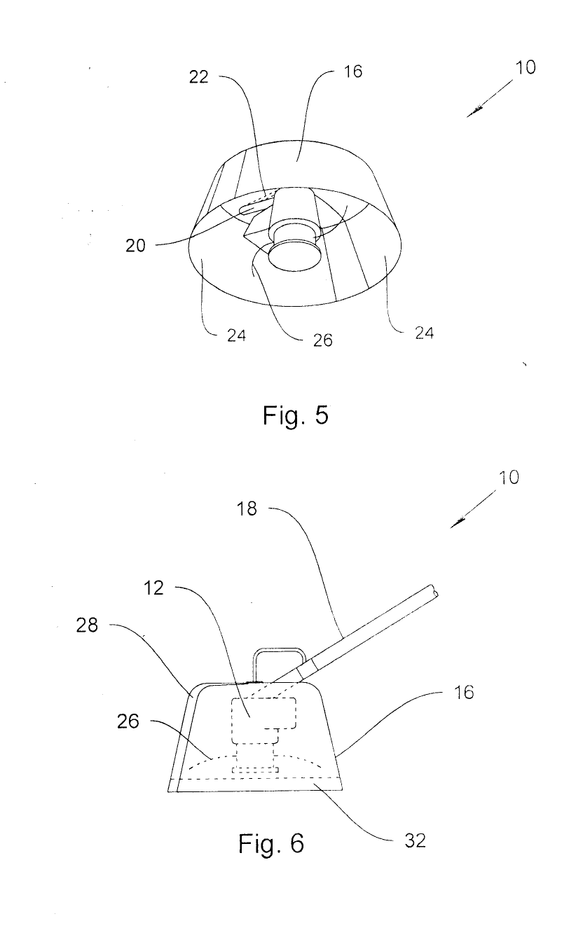

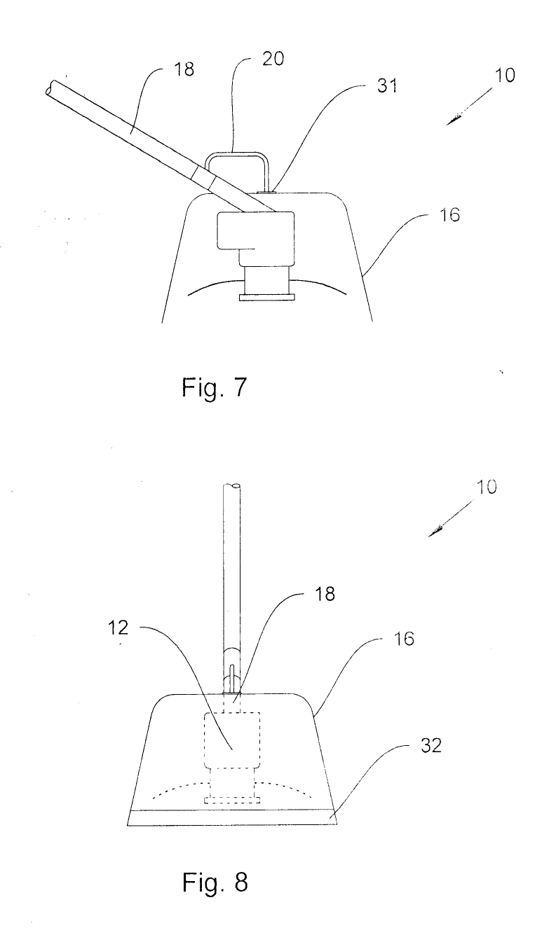

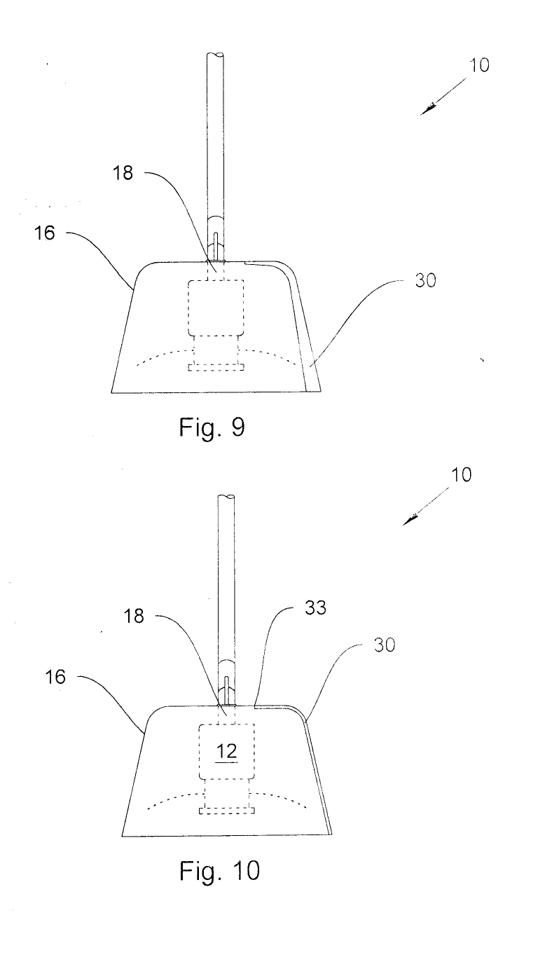

### DETAILED DESCRIPTION OF THE INVENTION

The present invention, hereinafter referred to as a Protective Shield Apparatus, indicated generally at 10, providing a protective shield capable of being fastened over the cutting or trimmer head 12 of a power trimmer 14, thereby providing a 360-degree protective housing and dramatically reducing or eliminating the trimmer's hazardous tendency to “throw” debris out as it trims with a cutting wire or string 26. The Protective Shield Apparatus is preferably an add-on, aftermarket accessory for existing gas- and electric-powered power trimmers 14, intended to correct a design deficiency in the power trimmers 14 by adding a protective “dome” shield 16 above the trimmer head 12. The trimmer head 12 is attached to a lower shaft 18 of the power trimmer 14 as understood by those persons skilled in the art. It should be understood that the exemplary embodiment(s) may be used to protective a variety of rotatable power trimmers 14, and should not be limited to any particular power trimmer 14 described and/or shown herein.

Referring to the figures in general, in a non-limiting exemplary embodiment(s), as briefly stated above, the Protective Shield Apparatus 10 of the present invention includes a telescopic adjusting rod 20 having a first end and a second end. The first end of the telescoping rod 20 is secured to the lower shaft of the power trimmer 14 via a clamp-type mount secured by either a fitted nut-and-bolt or (for greater user convenience) by a thumb-and-finger screw clamp. The telescoping rod 20 extends from the lower shaft 18 of the power trimmer 14 substantially over the trimmer head 12 of the power trimmer 14. The telescoping rod 20 can be extended, retracted, and releasably locked in a desired position allowing the Protective Shield Apparatus 10 to fit and accommodate most power trimmers 14.

The Protective Shield Apparatus 10 of the present invention further includes the dome cover 16 secured to the second end of the telescopic adjusting rod 20. Through a centered fitting, the dome cover 16 mounts to the second end of the telescoping rod 20 above the trimmer head 12 with an approximately two (2″) inches to approximately four (4″) inches round washer 31 provided for the middle, the top, and the bottom of the dome cover 20 for connections. Below the mount, the dome cover 20 is preferably secured to the telescoping rod 20 by a gimbal bearing 22, such that the dome cover 20 remains at a horizontal position, parallel with the ground and above the trimmer head 12, even when the trimmer head 12 is being used at an angle.

Preferably, the dome cover 12 of the Protective Shield Apparatus 10 of the present invention is approximately twenty (20″) inches wide and eight (8″) inches deep that at least partially encompasses the trimmer head 12 of the power trimmer 14. Preferably, the dome cover 16 completely encompasses the trimmer head 12 to maximize the protection to the user.

Additionally, the dome cover 16 of the Protective Shield Apparatus 10 of the present invention is adjustable in height. The dome cover 16 can be raised about the telescoping rod 20 such that the dome cover 16 is positioned off the ground and locked into place while heavy trimming. When finished, the dome cover 16 can be returned to its original position against the ground and releasably locked in place during general vegetation cutting.

In addition, the Protective Shield Apparatus 10 of the present invention includes at least one cutting blade 24 mounted inside the dome cover 20 for trimming the cutting wire 26 to the correct length if it gets too long. In another embodiment of the present invention, a cutting surface 28, such as a slit, can be formed in the dome cover 16 to trim the cutting wire 26. The slit 28 preferably extends up to the top of the dome cover 16, instead of just at the bottom like the cutting blades 24.

Further, at least one section, but preferably two, of the dome cover 16 of the Protective Shield Apparatus 10 of the present invention, approximately twenty-two)(22°) degrees of the circle, rises approximately two (2″) inches to facilitate trimming the edge of raised sidewalks and curbs. Left and right side adjusting flaps 30 are provided for these types of trimming purposes and are releasably lockable in place. In an alternative embodiment, the flaps 30 are slidable in a general direction up the dome cover 16 and are secured in position by a mechanical latching mechanism 33, friction, or the like. Rails or other guides can be provided on the outer surface of the dome cover 16 for the flaps 30.

The dome cover 16 of the Protective Shield Apparatus 10 of the present invention is preferably constructed from a tough, durable, UV- and and impact-resistant, possibly transparent thermoplastic polymer, perhaps ABS (Acrylonitrile Butadiene Styrene) plastic, which in some formulations does permit a combination of strength, durability, and transparency. It should be noted that while the dome cover 16 has been described as being constructed from a specific material, it is within the scope of the present invention to construct the dome cover 16 from other materials.

In a non-limiting exemplary embodiment, the dome cover 16 of the Protective Shield Apparatus 10 of the present invention will be roughly hemispherical, measuring approximately twelve (12″) inches in diameter by approximately five (5″) inches in maximum height. Also, as understood by those persons skilled in the art, it should be noted that the Protective Shield Apparatus 10, while initially conceived and designed as a “retrofit accessory” for existing power trimmers 14, can also be incorporated into the design and manufacture of new power trimmers 14.

The virtue of the dome cover 16 of the Protective Shield Apparatus 10 of the present invention is clear and straightforward, and will be immediately apparent to anyone who has used a string-type weed-whacker or weed-trimmer 14. The Protective Shield Apparatus 10, simply and effectively, places a protective barrier between the trimming head 12 and the surrounding area, people, and property, preventing the power trimmer 14 from throwing out debris as it trims. The dome cover 12 of the Protective Shield Apparatus 10 is preferably transparent, enabling the operator to easily see what he or she is doing; and the gimbal mounting mechanism 22 will keep the dome cover 12 oriented over the trimming head 12, regardless of the trimming head's angle and orientation. Designed for easy installation and use with virtually any gas- or electrically powered power trimmer 14.

The dome cover 12 of the Protective Shield Apparatus 10 of the present invention is preferably fabricated in a tough, durable, UV- and impact-resistant, possibly transparent thermoplastic polymer, which in some formulations permits a combination of strength, durability, and transparency. The bottom of dome cover 16 is preferably reinforced with a two (2″) inch band or shield 32 of a tin, aluminum, or other metal material for added protection and durability to prevent cracking. As its name suggests, the dome cover 16 is roughly hemispherical, measuring approximately twelve (12″) inches in diameter by five (5″) inches in maximum height.

As stated above, through a centered fitting, the dome cover 16 mounts to the lower shaft of the power trimmer 14, just above the trimming head 12, via a clamp-type mount secured by either a fitted nut-and-bolt or by a thumb-and-finger screw clamp. Below this mount, the dome cover 16 is secured by the gimbal bearing 22, such that the dome cover 16 remains at the horizontal even when the trimmer head 12 is being used at an angle. Further, one section of the dome cover 16, approximately twenty-two (22°) degrees of the circle rises approximately two (2″) inches to facilitate trimming the edge of raised sidewalks and curbs.

The Protective Shield Apparatus 10 of the present invention, simply and effectively, places a protective barrier between the trimming head and the surrounding area, people, and property, preventing the power trimmer 14 from throwing out debris as it trims. Designed for easy installation and use with virtually any weed-trimmer, the Protective Shield Apparatus 10 should find a wide and enthusiastic reception-in the lawn-care markets of America and the world.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A protective shield apparatus for a power trimmer, the power trimmer having a lower shaft with a trimmer head attached thereto, the trimmer head spinning a trimmer wire, the protective shield apparatus comprising:
a telescopic adjusting rod having a first end and a second end, the first end of the rod capable of being secured to the lower shaft of the power trimmer; and
a dome cover secured to the second end of the telescopic adjusting rod by a gimbal bearing;
wherein the dome cover remains at a horizontal position, parallel with a ground surface and above the trimmer head, even when the trimmer head is being used at an angle; and
wherein the dome cover reduces the power trimmer's hazardous tendency to “throw” debris out as it trims.

2. The protective shield apparatus of claim 1 wherein the first end of the telescoping rod is secured to the lower shaft by a clamp-type mount secured by a mechanism selected from the group consisting of a fitted nut-and-bolt and a thumb-and-finger screw clamp.

3. The protective shield apparatus of claim 1 wherein the telescoping rod is capable of extending from the lower shaft of the power trimmer substantially over the trimmer head of the power trimmer.

4. The protective shield apparatus of claim 1 wherein the dome cover mounts to the second end of the rod above the trimmer head through a centered fitting.

5. The protective shield apparatus of claim 1 wherein the dome cover at least partially encompasses the trimmer head of the power trimmer.

6. The protective shield apparatus of claim 1 wherein the dome cover completely encompasses the trimmer head of the power trimmer.

7. The protective shield apparatus of claim 1 and further comprising:
at least one cutting blade mounted inside the dome cover capable of trimming the cutting wire to a desired length.

8. The protective shield apparatus of claim 7 and further comprising:
a pair of cutting blades mounted to an inside surface of the dome cover opposite each other.

9. The protective shield apparatus of claim 1 and further comprising:
a cutting surface formed in the dome cover to trim the cutting wire.

10. The protective shield apparatus of claim 9 wherein tile cutting surface is a slit extending to a top of the dome cover.

11. The protective shield apparatus of claim 1 wherein the dome cover is adjustable in height such that the dome cover can be raised off a ground surface and releasably locked into place while heavy trimming and lowered down against the ground and releasably locked into place.

12. The protective shield apparatus of claim 1 and further comprising:
a pair of opposite flaps formed in the dome cover.

13. The protective shield apparatus of claim 12 wherein the flaps are slidable along a surface of the dome and releasably securable in an open position.

14. The protective shield apparatus of claim 1 and further comprising:
a metal band around an open end of the dome cover opposite the telescopic adjusting arm.

15. A method for constructing a protective shield apparatus for a power trimmer, the power trimmer having a lower shaft with a trimmer head attached thereto, the trimmer head spinning a trimmer wire, the method comprising:
providing a telescopic adjusting rod having a first end and a second end;
securing the first end of the rod to the lower shaft of the power trimmer;
securing a dome cover to the second end of the telescopic adjusting rod by a gimbal bearing;
maintaining the dome cover at a horizontal position, parallel with a ground surface and above the trimmer head, even when the trimmer head is being used at an angle; and
reducing the power trimmer's hazardous tendency to “throw” debris out as it trims.

16. A protective shield apparatus for a power trimmer, the power trimmer having a lower shaft with a trimmer head attached thereto, the trimmer head spinning a trimmer wire, the protective shield apparatus comprising:
a telescopic adjusting rod having a first end and a second end, the first end of the rod capable of being secured to the lower shaft of the power trimmer, the telescopic adjusting rod extending from the lower shaft of the power trimmer substantially over the trimmer head of the power trimmer;
a transparent dome cover secured to the second end of the telescopic adjusting rod by a gimbal bearing;
at least one cutting means associated with the dome cover for trimming the cutting wire to a desired length; and
a pair of opposite flaps formed in the dome cover, the flaps slidable in a general direction up the dome and releasably securable in place;
wherein the dome cover remains at a horizontal position, parallel with a ground surface and above the trimmer head, even when the trimmer head is being used at an angle; and
wherein the dome cover reduces the power trimmer's hazardous tendency to “throw” debris out as it trims.

17. The protective shield apparatus of claim 15 wherein the dome cover completely encompasses the trimmer head of the power trimmer.

18. The protective shield apparatus of claim 15 wherein the cutting means is a pair of cutting blades mounted to an inside surface of the dome cover opposite each other.

19. The protective shield apparatus of claim 15 wherein the cutting means is a slit extending to a top of the dome cover.

20. The protective shield apparatus of claim 15 wherein the dome cover is adjustable in height such that the dome cover can he raised off a ground surface and releasably locked into place while heavy trimming and lowered down against the ground and releasably locked into place.
